(19) United States
(12) Patent Application Publication
(10) Pub. No.: US 2025/0207553 A1
(43) Pub. Date: Jun. 26, 2025

(54) COMPLIANTLY MOUNTED LABYRINTH SEAL

(71) Applicant: BHE Turbomachinery, LLC, Portland, OR (US)

(72) Inventor: Henry K. Obermeyer, Wellington, CO (US)

(21) Appl. No.: 18/999,863

(22) Filed: Dec. 23, 2024

Related U.S. Application Data
(60) Provisional application No. 63/614,145, filed on Dec. 22, 2023.

(51) Int. Cl. F03B 11/00; F01D 11/02

(52) U.S. Cl. CPC F03B 11/006; F01D 11/02; F05B 2240/57; F05D 2240/55

(57) ABSTRACT

A labyrinth seal for sealing between a rotating portion and a non-rotating portion of rotating machinery, the labyrinth seal having a first portion and a second portion. The first portion has a series of projections and recessions that are concentric about an axis of rotation of the rotating portion of the rotating machinery. The second portion has a series of projections and recessions that are concentric about the axis of rotation. The projections of the series of projections and recessions of the second portion are configured to mate with the recessions of the series of projections and recessions of the first portion. The projections of the series of projections and recessions of the first portion are configured to mate with the recessions of the series of projections and recessions of the second portion. The second portion includes a mount having a substantially rigid layer sandwiched between substantially compliant layers.

### CROSS-REFERENCES TO RELATED APPLICATIONS

This patent application claims the benefit of provisional Application No. 63/614,145 filed Dec. 22, 2023. That application is incorporated into the present disclosure by this reference.

### TECHNICAL FIELD

The subject matter is related to an apparatus and methods for sealing between rotating and non-rotating components of a machine, and, more particularly, to an apparatus and methods for sealing between the inlets and outlets of hydromotive machines such as centrifugal pumps, hydraulic turbines, reversible pump turbines, and the like.

### BACKGROUND

Labyrinth seals are well known in the art of centrifugal pumps, Francis turbines, and reversible pump turbines. A typical vertical centrifugal pump, for example, utilizes two labyrinth seal assemblies; one to seal the crown of the impeller to the head cover at a radius that minimizes axial thrust on the impeller, and a second to establish a seal between the band and the bottom plate. The space between the impeller crown and the head cover and between the main shaft and the labyrinth seal is typically vented to the suction side of the impeller to balance pressure forces across the impeller and to minimize pressure on the main shaft seal. Leakage across labyrinth seals results in efficiency and pumping capacity losses and contributes to seal wear as abrasive contaminates are carried in with the leakage flow. Such seals must be provided with sufficient axially clearance to avoid interference and unintended contact and undue wear between the rotating and the non-rotating elements of the labyrinth seals. The required axial clearance is typically greater than is the required radial clearance. The radial clearance must in any case be sufficient to avoid contact between the rotating and non-rotating elements. In implementations using previously-existing labyrinth seals, the radial clearance must allow for dynamic radial excursions of shaft position.

Configurations of the disclosed technology address shortcomings in the prior art.

### BRIEF DESCRIPTION OF THE DRAWINGS

FIG. 1 is a cross section of an example hydromotive machine having labyrinth seals according to an example configuration.

FIG. 2 is a detailed view of a portion of the example hydromotive machine of FIG. 1.

FIG. 3 is similar to FIG. 2 but illustrates another example configuration of the labyrinth seals.

FIG. 4 illustrates a portion of the labyrinth seals of FIG. 3 in isolation to show the example lubrication grooves.

### DETAILED DESCRIPTION

As described in this document, aspects are directed to a labyrinth seal with particular application to sealing between relatively high-pressure and relatively low-pressure sections of a hydromotive machine. In configurations of the disclosed technology, the stationary elements of the labyrinth seal assembly may be mounted in a radially compliant manner to allow the stationary elements of the labyrinth seal to be temporarily pushed out of the way of the rotating labyrinth seal elements in the event of a shaft excursion resulting from cavitation, debris passage, water hammer, overspeed, or the like. This allows the labyrinth seal assembly in accordance with the disclosed technology to be provided with tighter radial clearances that result in lower leakage rates, lower wear rates, and improved hydraulic efficiency.

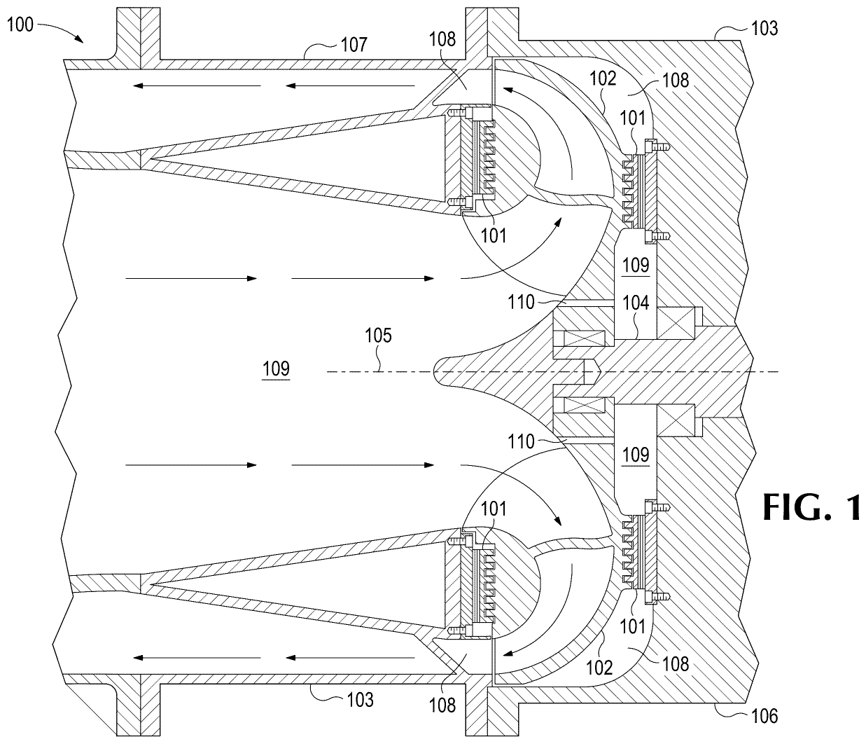

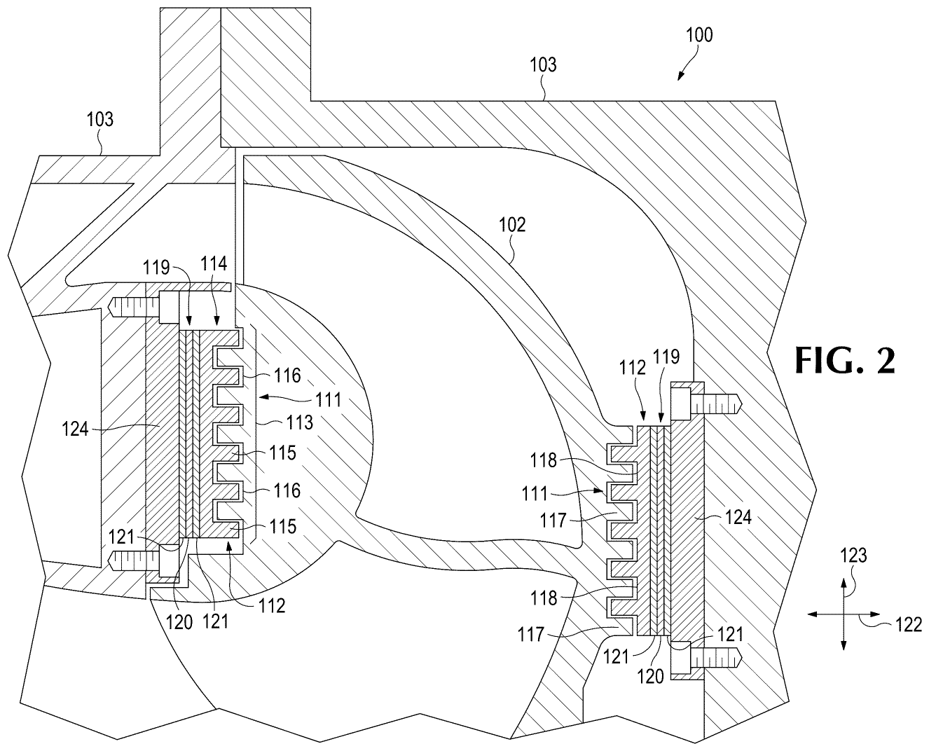

FIG. 1 is a cross section of an example hydromotive machine 100 having labyrinth seals 101 according to an example configuration. FIG. 2 is a detailed view of a portion of the example hydromotive machine 100 of FIG. 1. The hydromotive machine 100 may be, as examples, a pump, a reversible pump-turbine, a turbine, a blower, a compressor, a turbocharger, a supercharger, or a gas turbine. As illustrated in FIGS. 1 and 2, the hydromotive machine 100 includes a blade assembly 102, one or more non-rotating portions 103, and one or more labyrinth seals 101.

The blade assembly 102 is configured to rotate on a shaft 104 about an axis of rotation 105. The blade assembly 102 could be, for example, the impeller blades of a pump, a reversible pump-turbine in pump mode, a blower, a compressor, a turbocharger, or a supercharger. Alternatively, blade assembly 102 could be, for example, the runner blades of a reversible pump-turbine in turbine mode, a turbine, or a gas turbine.

The non-rotating portions 103 may be, for example, the portion 106 of the hydromotive machine 100 where the rotating shaft 104 is mounted or another portion of the hydromotive machine 100 that adjoins the blade assembly 102, such as the diffuser section 107 illustrated in FIG. 1.

The labyrinth seals 101 are between the blade assembly 102 and the non-rotating portion 103 and are intended to reduce leakage of fluid across the labyrinth seal 101. With reference to the example hydromotive machine 100 illustrated in FIG. 1, the labyrinth seals 101 reduce leakage from the relatively high-pressure zones 108 to the relatively low-pressure zones 109. By minimizing leakage, the labyrinth seals 101 allow the vent holes 110 to carry any leaked fluid to the low-pressure side of the blade assembly 102. Accordingly, the net hydraulic thrust on the blade assembly 102 and the resulting bearing loads may be significantly reduced.

With particular reference to FIG. 2, the illustrated labyrinth seal 101 includes two portions, referred to here as a first portion 111 and a second portion 112. As illustrated, the first portion 111 of the labyrinth seal 101 has a series of projections and recessions that are concentric about the axis of rotation 105. Likewise, the second portion 112 of the labyrinth seal 101 has a series of projections and recessions that are concentric about the axis of rotation 105. The projections 115 of the series 114 of projections and recessions of the second portion 112 are configured to mate with the recessions 116 of the series 113 of projections and recessions of the first portion 111. Similarly, the projections 117 of the series 113 of projections and recessions of the first portion 111 are configured to mate with the recessions 118 of the series 114 of projections and recessions of the second portion 112.

Preferably, the materials are chosen such that the series 113 of projections and recessions of the first portion 111 do not friction weld to the series 114 of projections and recessions of the second portion 112 during use of the labyrinth seal 101. Accordingly, the rotating projections and recessions may be made of, for example, stainless steel, while the non-rotating projections and recessions may be made of, for example, bronze. It is also desirable for one of the materials (preferably the material of the non-rotating projections and recessions) to be able to either plastically or elastically deform to accommodate abrasive particles that might enter the labyrinth seal 101. The damage caused by abrasive particles that might enter the labyrinth seal 101 may be reduced by such deformation. Bronze, for example, can plastically deform to absorb abrasive particles. In addition, elastomers, such as various rubber compounds, can elastically deform to accommodate abrasive particles.

In addition, the second portion 112 includes a mount 119 having a substantially rigid layer 120 sandwiched between substantially compliant layers 121. As used in this context, “substantially rigid” means largely or essentially stiff and not pliant, without requiring perfect inflexibility. As used in this context, “substantially compliant” means largely or essentially pliable, without requiring perfect flexibility. In configurations, the rigid layer 120 of the mount 119 is a rigid metal alloy such as, for example, steel. In configurations, the compliant layers 121 of the mount 119 are an elastomeric polymer such as, for example, rubber. This lamination stack of a rigid layer 120 and compliant layers 121 provides high stiffness in the direction 122 indicated in FIG. 2 and flexibility in the direction 123 indicated in FIG. 2. While the drawings illustrate a single set of alternating layers (that is, compliant layer-rigid layer-compliant layer), additional sets of alternating layers are contemplated in some configurations.

In configurations, the mount 119 is configured to mount the second portion 112 of the labyrinth seal 101 to the non-rotating portion 103 of the rotating machinery, perhaps through a base mounting plate 124 as illustrated in the drawings. In such configurations, the first portion 111 of the labyrinth seal 101 may be machined into the rotating portion of the rotating machinery. In other configurations, the mount 119 is configured to mount second portion 112 of the labyrinth seal 101 to the rotating portion of the rotating machinery.

The purpose of the mount 119 is to limit radial loads on the labyrinth seal 101. Specifically, the mount 119 allows the non-rotating portion 103 of the labyrinth seal 101 to move in response to excursions of the rotating portion of the labyrinth seal 101. Accordingly, the non-rotating portion 103 of the labyrinth seal 101 can better withstand occasional contact with the rotating portion of the labyrinth seal 101 and without unduly wearing the projections and recessions of the labyrinth seal 101 elements.

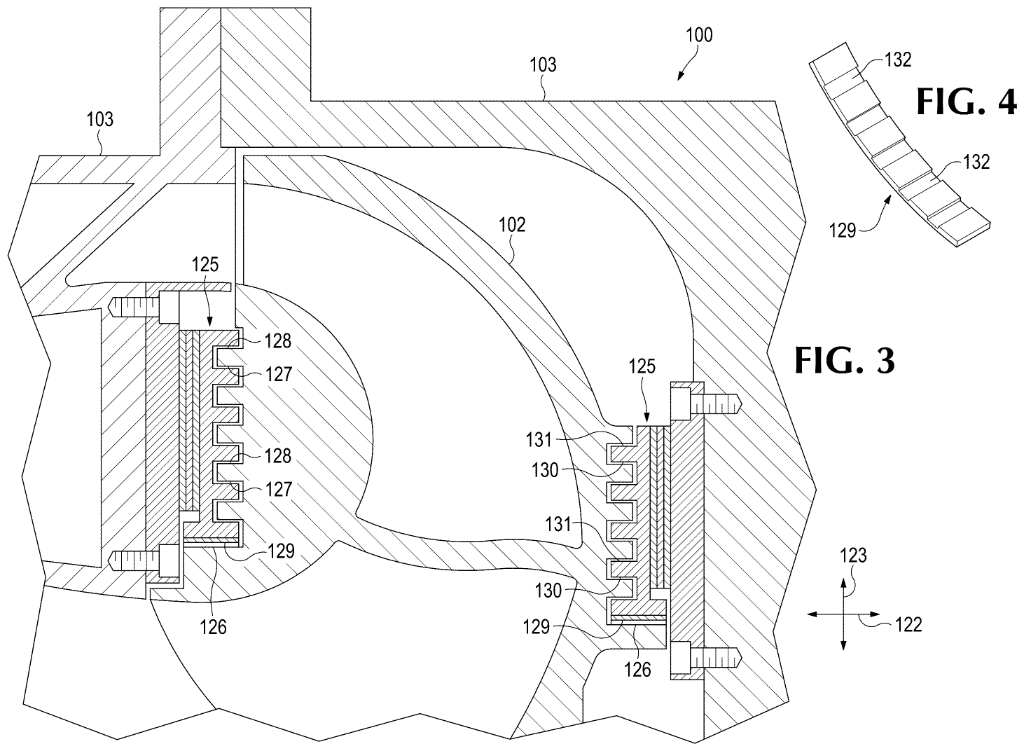

FIG. 3 is similar to FIG. 2 but illustrates another example configuration of the labyrinth seals 125. FIG. 4 illustrates a portion of the labyrinth seals 125 of FIG. 3 in isolation. The labyrinth seals 125 of FIG. 3 are identical to the labyrinth seals 101 of FIGS. 1 and 2 except as noted here. Accordingly, in configurations the labyrinth seals 125 of FIG. 3 may be substituted for the labyrinth seals 125 of FIGS. 1 and 2.

As illustrated in FIG. 3, the first portion 111 of the labyrinth seal 125 may also include a bearing surface 126 that is concentric to the series 113 of projections and recessions of the first portion 111. The bearing surface 126 of the first portion 111 of the labyrinth seal 125 has a radial surface area, which is the area of the bearing surface 126 indicated in FIG. 3.

To better explain the bearing surface 126 of the first portion 111 of the labyrinth seal 125, each projection of the series 113 of projections and recessions of the first portion 111 has a first radial side 127 and a second radial side 128. The second radial side 128 is radially farther from the bearing surface 126 of the first portion 111 of the labyrinth seal 125 than the first radial side 127 is from the bearing surface 126 of the first portion 111 of the labyrinth seal 125. The first radial side 127 of each projection has a surface area, which is the area of the respective surface indicated in FIG. 3. The radial surface area of the bearing surface 126 of the first portion 111 of the labyrinth seal 125 is greater than the surface area of the first radial side 127 of each individual projection of the series 113 of projections and recessions of the first portion 111. The bearing surface 126 of the first portion 111 of the labyrinth seal 125, in having a greater surface area, helps to keep the first portion 111 of the labyrinth seal 125 aligned with the second portion 112 of the labyrinth seal 125 without undue wear on the series 113 of projections and recessions of the first portion 111.

As illustrated in FIG. 3, the second portion 112 of the labyrinth seal 125 also includes a bearing surface 129 that is concentric to the series 114 of projections and recessions of the second portion 112. The bearing surface 129 of the second portion 112 is configured to engage the bearing surface 126 of the first portion 111 of the labyrinth seal 125 by contacting it. The bearing surface 129 of the second portion 112 of the labyrinth seal 125 has a radial surface area, which is the area of the bearing surface 129 indicated in FIG. 3.

Each projection of the series 114 of projections and recessions of the second portion 112 has a first radial side 130 and a second radial side 131. The second radial side 131 is radially farther from the bearing surface 129 of the second portion 112 of the labyrinth seal 125 than the first radial side 130 is from the bearing surface 129 of the second portion 112 of the labyrinth seal 125. The first radial side 130 of each projection has a surface area, which is the area of the respective surface indicated in FIG. 3. The radial surface area of the bearing surface 129 of the second portion 112 of the labyrinth seal 125 is greater than the surface area of the first radial side 130 of each individual projection of the series 114 of projections and recessions of the second portion 112. The bearing surface 129 of the second portion 112 of the labyrinth seal 125, in having a greater surface area, helps to keep the first portion 111 of the labyrinth seal 125 aligned with the second portion 112 of the labyrinth seal 125 without undue wear on the series 114 of projections and recessions of the second portion 112.

The bearing elements described here for FIG. 3 help to keep the non-rotating portion 103 of the labyrinth seal 125 concentric with the axis of rotation 105 of the rotating portion of the labyrinth seal 125.

In configurations, the bearing surface 126 of the first portion 111 of the labyrinth seal 125 is radially farther from the axis of rotation 105 than the series 113 of projections and recessions of the first portion 111. In other words, the bearing surface 126 is at the outer diameter of the labyrinth seal 125 in such configurations. In other configurations, the bearing surface 126 of the first portion 111 of the labyrinth seal 125 is radially closer to the axis of rotation 105 than the series 113 of projections and recessions of the first portion 111. In other words, the bearing surface 126 is at the inner diameter of the labyrinth seal 125 in such configurations.

In configurations, the bearing surface 126 of the first portion 111 of the labyrinth seal 125 is machined into the rotating portion of the rotating machinery. In configurations, the bearing surface 129 of the second portion 112 of the labyrinth seal 125 is an elastomeric polymer. The purpose of the such an elastomeric bearing surface 129 is to resist damage from abrasive particles that may be present in the fluid.

As best illustrated in FIG. 4, in configurations the bearing surface 129 of the second portion 112 of the labyrinth seal 125 includes axial lubrication grooves 132. These lubrication grooves 132 facilitate the formation of a hydrodynamic film between the bearing surface 129 of the first portion 111 of the labyrinth seal 125 and the bearing surface 129 of the second portion 112 of the labyrinth seal 125.

Although described above in the context of a hydromotive machine, the disclosed labyrinth seals may be used to seal between other rotating and non-rotating components of a machine. Additionally, although described above in the context of a labyrinth seal, the disclosed technology—including the mount and the bearing surfaces—also apply to other types of seal, including, for example, a two-phase seal or ice seal (an example of which is described in U.S. Pat. No. 3,612,713).

### EXAMPLES

Illustrative examples of the disclosed technologies are provided below. A particular configuration of the technologies may include one or more, and any combination of, the examples described below.

Example 1 includes a labyrinth seal for sealing between a rotating portion and a non-rotating portion of rotating machinery, the labyrinth seal comprising: a first portion having a series of projections and recessions that are concentric about an axis of rotation of the rotating portion of the rotating machinery; and a second portion having a series of projections and recessions that are concentric about the axis of rotation, the projections of the series of projections and recessions of the second portion are configured to mate with the recessions of the series of projections and recessions of the first portion, the projections of the series of projections and recessions of the first portion are configured to mate with the recessions of the series of projections and recessions of the second portion, the second portion further comprising a mount having a substantially rigid layer sandwiched between substantially compliant layers.

Example 2 includes the labyrinth seal of Example 1, in which the mount is configured to mount the second portion of the labyrinth seal to the non-rotating portion of the rotating machinery.

Example 3 includes the labyrinth seal of Example 2, in which the first portion of the labyrinth seal is machined into the rotating portion of the rotating machinery.

Example 4 includes the labyrinth seal of Example 1, in which the mount is configured to mount the second portion of the labyrinth seal to the rotating portion of the rotating machinery.

Example 5 includes the labyrinth seal of any of Examples 1-4, in which the rigid layer is a rigid metal alloy.

Example 6 includes the labyrinth seal of any of Examples 1-5, in which the compliant layer is an elastomeric polymer.

Example 7 includes the labyrinth seal of any of Examples 1-6, in which the first portion of the labyrinth seal further comprises a bearing surface that is concentric to the series of projections and recessions of the first portion, the bearing surface of the first portion of the labyrinth seal having a radial surface area, in which each projection of the series of projections and recessions of the first portion has a first radial side and a second radial side, the second radial side being radially farther from the bearing surface of the first portion of the labyrinth seal than the first radial side is from the bearing surface of the first portion of the labyrinth seal, each first radial side of each projection having a surface area, in which the radial surface area of the bearing surface of the first portion of the labyrinth seal is greater than the surface area of the first radial side of each projection of the series of projections and recessions of the first portion; and the second portion of the labyrinth seal further comprising a bearing surface that is concentric to the series of projections and recessions of the second portion, in which the bearing surface of the second portion is configured to engage the bearing surface of the first portion of the labyrinth seal, in which each projection of the series of projections and recessions of the second portion has a first radial side and a second radial side, the second radial side being radially farther from the bearing surface of the second portion of the labyrinth seal than the first radial side is from the bearing surface of the second portion of the labyrinth seal, each first radial side of each projection having a surface area, in which the radial surface area of the bearing surface of the second portion of the labyrinth seal is greater than the surface area of the first radial side of each projection of the series of projections and recessions of the second portion.

Example 8 includes the labyrinth seal of Example 7, in which the bearing surface of the first portion of the labyrinth seal is radially farther from the axis of rotation than the series of projections and recessions of the first portion.

Example 9 includes the labyrinth seal of Example 7, in which the bearing surface of the first portion of the labyrinth seal is radially closer to the axis of rotation than the series of projections and recessions of the first portion.

Example 10 includes the labyrinth seal of any of Examples 7-9, the bearing surface of the second portion of the labyrinth seal further comprising axial lubrication grooves.

Example 11 includes the labyrinth seal of any of Examples 7-10, in which the bearing surface of the first portion of the labyrinth seal is machined into the rotating portion of the rotating machinery.

Example 12 includes the labyrinth seal of any of Examples 7-11, in which the bearing surface of the second portion of the labyrinth seal is an elastomeric polymer.

Example 13 includes a hydromotive machine comprising: a blade assembly configured to rotate about an axis of rotation; a non-rotating portion; a labyrinth seal between the blade assembly and the non-rotating portion, the labyrinth seal comprising: a first portion having a series of projections and recessions that are concentric about the axis of rotation, and a second portion having a series of projections and recessions that are concentric about the axis of rotation, the projections of the series of projections and recessions of the second portion are configured to mate with the recessions of the series of projections and recessions of the first portion, the projections of the series of projections and recessions of the first portion are configured to mate with the recessions of the series of projections and recessions of the second portion, the second portion further comprising a mount having a substantially rigid layer sandwiched between substantially compliant layers.

Example 14 includes the hydromotive machine of Example 13, in which the mount is configured to mount the second portion of the labyrinth seal to the non-rotating portion.

Example 15 includes the hydromotive machine of Example 14, in which the first portion of the labyrinth seal is machined into the blade assembly.

Example 16 includes the hydromotive machine of Example 13, in which the mount is configured to mount the second portion of the labyrinth seal to the blade assembly.

Example 17 includes the hydromotive machine of any of Examples 13-16, in which the rigid layer is a rigid metal alloy.

Example 18 includes the hydromotive machine of any of Examples 13-17, in which the compliant layer is an elastomeric polymer.

Example 19 includes the hydromotive machine of any of Examples 13-18, in which the first portion of the labyrinth seal further comprises a bearing surface that is concentric to the series of projections and recessions of the first portion, the bearing surface of the first portion of the labyrinth seal having a radial surface area, in which each projection of the series of projections and recessions of the first portion has a first radial side and a second radial side, the second radial side being radially farther from the bearing surface of the first portion of the labyrinth seal than the first radial side is from the bearing surface of the first portion of the labyrinth seal, each first radial side of each projection having a surface area, in which the radial surface area of the bearing surface of the first portion of the labyrinth seal is greater than the surface area of the first radial side of each projection of the series of projections and recessions of the first portion; and the second portion of the labyrinth seal further comprising a bearing surface that is concentric to the series of projections and recessions of the second portion, in which the bearing surface of the second portion is configured to engage the bearing surface of the first portion of the labyrinth seal, in which each projection of the series of projections and recessions of the second portion has a first radial side and a second radial side, the second radial side being radially farther from the bearing surface of the second portion of the labyrinth seal than the first radial side is from the bearing surface of the second portion of the labyrinth seal, each first radial side of each projection having a surface area, in which the radial surface area of the bearing surface of the second portion of the labyrinth seal is greater than the surface area of the first radial side of each projection of the series of projections and recessions of the second portion.

Example 20 includes the hydromotive machine of Example 19, in which the bearing surface of the first portion of the labyrinth seal is radially farther from the axis of rotation than the series of projections and recessions of the first portion.

Example 21 includes the hydromotive machine of Example 19, in which the bearing surface of the first portion of the labyrinth seal is radially closer to the axis of rotation than the series of projections and recessions of the first portion.

Example 22 includes the hydromotive machine of any of Examples 19-21, the bearing surface of the second portion of the labyrinth seal further comprising axial lubrication grooves.

Example 23 includes the hydromotive machine of any of Examples 19-22, in which the bearing surface of the first portion of the labyrinth seal is machined into the blade assembly.

Example 24 includes the hydromotive machine of any of Examples 19-23, in which the bearing surface of the second portion of the labyrinth seal is an elastomeric polymer.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I (or we) claim:

1. A labyrinth seal for sealing between a rotating portion and a non-rotating portion of rotating machinery, the labyrinth seal comprising:
a first portion having a series of projections and recessions that are concentric about an axis of rotation of the rotating portion of the rotating machinery; and
a second portion having a series of projections and recessions that are concentric about the axis of rotation, the projections of the series of projections and recessions of the second portion are configured to mate with the recessions of the series of projections and recessions of the first portion, the projections of the series of projections and recessions of the first portion are configured to mate with the recessions of the series of projections and recessions of the second portion, the second portion further comprising a mount having a substantially rigid layer sandwiched between substantially compliant layers.

2. The labyrinth seal of claim 1, in which the mount is configured to mount the second portion of the labyrinth seal to the non-rotating portion of the rotating machinery.

3. The labyrinth seal of claim 2, in which the first portion of the labyrinth seal is machined into the rotating portion of the rotating machinery.

4. The labyrinth seal of claim 1, in which the mount is configured to mount the second portion of the labyrinth seal to the rotating portion of the rotating machinery.

5. The labyrinth seal of claim 1, in which the rigid layer is a rigid metal alloy.

6. The labyrinth seal of claim 1, in which the compliant layer is an elastomeric polymer.

7. The labyrinth seal of claim 1, in which the first portion of the labyrinth seal further comprises a bearing surface that is concentric to the series of projections and recessions of the first portion, the bearing surface of the first portion of the labyrinth seal having a radial surface area,
in which each projection of the series of projections and recessions of the first portion has a first radial side and a second radial side, the second radial side being radially farther from the bearing surface of the first portion of the labyrinth seal than the first radial side is from the bearing surface of the first portion of the labyrinth seal, each first radial side of each projection having a surface area, in which the radial surface area of the bearing surface of the first portion of the labyrinth seal is greater than the surface area of the first radial side of each projection of the series of projections and recessions of the first portion; and
the second portion of the labyrinth seal further comprising a bearing surface that is concentric to the series of projections and recessions of the second portion, in which the bearing surface of the second portion is configured to engage the bearing surface of the first portion of the labyrinth seal,
in which each projection of the series of projections and recessions of the second portion has a first radial side and a second radial side, the second radial side being radially farther from the bearing surface of the second portion of the labyrinth seal than the first radial side is from the bearing surface of the second portion of the labyrinth seal, each first radial side of each projection having a surface area, in which the radial surface area of the bearing surface of the second portion of the labyrinth seal is greater than the surface area of the first radial side of each projection of the series of projections and recessions of the second portion.

8. The labyrinth seal of claim 7, in which the bearing surface of the first portion of the labyrinth seal is radially farther from the axis of rotation than the series of projections and recessions of the first portion.

9. The labyrinth seal of claim 7, in which the bearing surface of the first portion of the labyrinth seal is radially closer to the axis of rotation than the series of projections and recessions of the first portion.

10. The labyrinth seal of claim 7, in which the bearing surface of the first portion of the labyrinth seal is machined into the rotating portion of the rotating machinery.

11. A hydromotive machine comprising:
a blade assembly configured to rotate about an axis of rotation;
a non-rotating portion;
a labyrinth seal between the blade assembly and the non-rotating portion, the labyrinth seal comprising:
a first portion having a series of projections and recessions that are concentric about the axis of rotation, and
a second portion having a series of projections and recessions that are concentric about the axis of rotation, the projections of the series of projections and recessions of the second portion are configured to mate with the recessions of the series of projections and recessions of the first portion, the projections of the series of projections and recessions of the first portion are configured to mate with the recessions of the series of projections and recessions of the second portion, the second portion further comprising a mount having a substantially rigid layer sandwiched between substantially compliant layers.

12. The hydromotive machine of claim 11, in which the mount is configured to mount the second portion of the labyrinth seal to the non-rotating portion.

13. The hydromotive machine of claim 12, in which the first portion of the labyrinth seal is machined into the blade assembly.

14. The hydromotive machine of claim 11, in which the mount is configured to mount the second portion of the labyrinth seal to the blade assembly.

15. The hydromotive machine of claim 11, in which the rigid layer is a rigid metal alloy.

16. The hydromotive machine of claim 11, in which the compliant layer is an elastomeric polymer.

17. The hydromotive machine of claim 11, in which the first portion of the labyrinth seal further comprises a bearing surface that is concentric to the series of projections and recessions of the first portion, the bearing surface of the first portion of the labyrinth seal having a radial surface area,
in which each projection of the series of projections and recessions of the first portion has a first radial side and a second radial side, the second radial side being radially farther from the bearing surface of the first portion of the labyrinth seal than the first radial side is from the bearing surface of the first portion of the labyrinth seal, each first radial side of each projection having a surface area, in which the radial surface area of the bearing surface of the first portion of the labyrinth seal is greater than the surface area of the first radial side of each projection of the series of projections and recessions of the first portion; and
the second portion of the labyrinth seal further comprising a bearing surface that is concentric to the series of projections and recessions of the second portion, in which the bearing surface of the second portion is configured to engage the bearing surface of the first portion of the labyrinth seal,
in which each projection of the series of projections and recessions of the second portion has a first radial side and a second radial side, the second radial side being radially farther from the bearing surface of the second portion of the labyrinth seal than the first radial side is from the bearing surface of the second portion of the labyrinth seal, each first radial side of each projection having a surface area, in which the radial surface area of the bearing surface of the second portion of the labyrinth seal is greater than the surface area of the first radial side of each projection of the series of projections and recessions of the second portion.

18. The hydromotive machine of claim 17, in which the bearing surface of the first portion of the labyrinth seal is radially farther from the axis of rotation than the series of projections and recessions of the first portion.

19. The hydromotive machine of claim 17, in which the bearing surface of the first portion of the labyrinth seal is radially closer to the axis of rotation than the series of projections and recessions of the first portion.

20. The hydromotive machine of claim 17, in which the bearing surface of the first portion of the labyrinth seal is machined into the blade assembly.
